(19) United States
(12) Patent Application Publication
(10) Pub. No.: US 2014/0073304 A1
(43) Pub. Date: Mar. 13, 2014

(54) DISTANCE-BASED MODIFICATION OF NEIGHBOR RELATIONS

(71) Applicants: Arthur Richard Brisebois, Cumming, GA (US); Thomas W. Henderson, Alpharetta, GA (US); Fereidoun Tafreshi, Bellevue, WA (US)

(72) Inventors: Arthur Richard Brisebois, Cumming, GA (US); Thomas W. Henderson, Alpharetta, GA (US); Fereidoun Tafreshi, Bellevue, WA (US)

(73) Assignee: AT&T MOBILITY II LLC, Atlanta, GA (US)

(21) Appl. No.: 13/609,038

(22) Filed: Sep. 10, 2012

(51) Int. Cl. H04W 4/00

(52) U.S. Cl. 455/418

(57) ABSTRACT

Adjusting RAN performance by adapting cell coverage area can help optimize a wireless network. Base station coverage areas can be determined by distance analysis of detected neighbor base stations. This can be in response to determination of a physical cell identifier (PCI) conflict condition. When a PCI conflict is determined, a unique identifier for each base station can be employed to facilitate determining location information for the base stations. Location information can be employed to determine distance-based characteristics that can facilitate adaptation of wireless network neighbor relations to adapt the RAN coverage area topology. Distance-based characteristics can include nearest neighbor, proximity to a predetermined distance, etc. Additionally, PCI information can be updated to correct the PCI conflict condition. Moreover, radio parameters can be adapted, including elevation, azimuth, and transmit power, to correct the PCI conflict condition by reducing overlap of coverage areas with matching PCI information.

### TECHNICAL FIELD

The disclosed subject matter relates to radio area network coverage and, more particularly, to adaptive radio area network coverage.

### BACKGROUND

By way of brief background, coverage area conditions for a radio area network (RAN) can be predicated on the features of the deployed RAN equipment, including base stations, e.g., NodeB or enhanced NodeB (eNodeB). A RAN can be comprised of a number of cells, each associated with a base station, e.g., a NodeB/eNodeB, mobile devices can traverse the RAN by sequentially establishing communications links with the base stations. Generally speaking, the closer a base station is to a mobile device, the higher quality the communications link will be, all else being equivalent, because the communications signals between the base station and the mobile device have a shorter distance to traverse.

Physical Cell Identifiers (PCIs) can be employed to identify base stations in a wireless network environment, e.g., RAN, cellular network, etc. As an example, approximately 500 distinct PCIs can be available. As such, different PCIs assigned to different LTE sector carriers can help to differentiate one LTE sector carrier from another of the same frequency. PCIs generally do not uniquely identify a base station across a wireless network given that there are typically far more base stations than PCI values, for example, there are far more than 500 base stations in most LTE cellular networks.

### BRIEF DESCRIPTION OF DRAWINGS

FIG. 1 is an illustration of a system that facilitates distance-based modification of neighbor relations in accordance with aspects of the subject disclosure.

FIG. 2 is a depiction of a system that facilitates distance-based modification of neighbor relations and conflict resolution in accordance with aspects of the subject disclosure.

FIG. 3 illustrates a system that facilitates distance-based modification of neighbor relations, conflict resolution, and coverage area adjustment in accordance with aspects of the subject disclosure.

FIG. 4 is a graphic of RAN conditions related to distance-based modification of neighbor relations in accordance with aspects of the subject disclosure.

FIG. 5 illustrates a method facilitating distance-based modification of neighbor relations in accordance with aspects of the subject disclosure.

FIG. 6 illustrates a method facilitating nearest neighbor distance-based modification of neighbor relations in accordance with aspects of the subject disclosure.

FIG. 7 illustrates a method for facilitating target neighbor distance distance-based modification of neighbor relations in accordance with aspects of the subject disclosure.

FIG. 8 illustrates a method for facilitating distance-based modification of neighbor relations and conflict resolution in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Adjusting RAN performance by adapting cell coverage area can help optimize the operating efficiency of a wireless network. Adjusting the selection of neighboring base stations based on the distance between base stations can result in improvements in the performance of a wireless communications network. As an example, selecting closer neighbor base stations as neighbors can result in each base station covering a smaller region and providing improved performance. As a second example, where an unplanned outage of a base station, e.g., a NodeB/eNodeB, occurs, adjusting nearby base station coverage areas can mitigate the effects of the outage.

Conventionally, RAN coverage conditions can be monitored and adapted in a non-automated manner, such as by deploying personnel to go out into the field to measure SNR values across portions of the RAN. Further, collected measurements can be manually subjected to analysis techniques to determine information, such as an SNR map of the RAN, which can then separately be employed in adaptation of the RAN or planning deployment of resources to improve the performance of the RAN. Moreover, conventional techniques can generally not be adapted to modern decentralized control processes that are becoming increasingly common in RAN operations, e.g., Long Term Evolution (LTE) cellular technologies can specify substantially more decentralized operations, such as Automatic Neighbor Relations (ANR) at each eNodeB, than preceding wireless network, e.g., cellular, technologies. As such, it can be desirable to provide tools that can determine information that can be employed in adapting coverage area conditions in a more automated manner and can be applied in a more decentralized control environment.

PCIs are widely used to help identify sector carriers, e.g., eNodeBs, because they consume fewer resources to transmit than a truly unique identifier, e.g., global cell identity (GCI) identifiers. As such, there can be instances where two base stations employ the same PCI in overlapping geographic regions resulting in an identification conflict, e.g., a PCI conflict. The conflict relates to each physical sector carrier of a base station having no more than one neighbor base station using a specific PCI. Where a serving base station has two or more neighbor base stations with the same PCI the serving base station can be unable to identify which neighbor base station to transfer a user equipment to during an event such as a handover. Ultimately, the identification conflict can result in the handover failing, because the two potential handover candidate base stations are not distinguishable from each other based on the PCI.

Increasing the number of PCIs can reduce the number of conflicts but typically increases the consumption of radio resources. Similarly, spacing the PCIs far enough apart can reduce conflict but can become burdensome as the density of base stations increases and/or the complexity of the RAN topology increases. The probability of conflict can increase dramatically where LTE networks are developed with missing eNodeBs or there are complex mixtures of small and large cells in a co-channel heterogeneous network. As an example, in a missing eNodeB scenario, a PCI plan can be developed with all eNodeBs in the plan, even though a significant number of them are physically missing while the infrastructure is built out. In this example, unexpected overlapping coverage and neighbor combinations (some with the same PCI) can occur because some base stations cover much more area than anticipated in the PCI plan. As a second example, in heterogeneous networks, there can be far more base stations causing overlapping coverage and complex neighbor relations within a confined area, which can result in a greater likelihood of PCI reuse and identification conflict.

Adapting cell coverage area in an automated manner, such as by integration with planning components and management components can be employed to, for example, anticipate future deployment of base stations to improve coverage areas, prioritization of base stations to improve coverage balance, etc. Historical information on coverage area patterns of base stations in a RAN can be employed, for example, to perform analysis of statistical coverage conditions for cells in a RAN, analysis of coverage areas as they relate to performance metrics, analysis of coverage areas with regard to specific event such as handovers, etc.

Mobile reporting components, e.g., user equipments (UEs), can be used to report detected base stations to automatic neighbor relations (ANR) components to facilitate selection of neighboring base stations in accordance with selection criteria and rules. In an aspect, UEs can report detected PCIs. Where an identification conflict occurs, distance-based modification of neighbor relations can be employed to select preferential neighboring base stations and/or to resolve the PCI identification conflict. Further, the automated collection of distance information to analyze RAN coverage conditions can facilitate adaptation of a RAN based on the distance information. In an aspect, adaptation of the RAN can include prioritization of base stations in neighbor relations technologies, e.g., Automatic Neighbor Relation (ANR) detection for self-organizing networks (SON) in Long Term Evolution (LTE) wireless radio technologies, etc. This can apply to ranking new potential neighbors. This can also apply to ranking existing neighbors, e.g., for retention, deletion, etc. Still further, distance information can be employed in RAN planning systems to promote evolution of RAN coverage according to one or more rules. Similarly, distance information can be employed for other purposes such as throwing alerts when RAN coverage diverges sufficiently from established parameters, deployment of maintenance services, sourcing information employed in automated mechanical adjustment of elevation, azimuth, or transmit power levels of base stations, etc., without departing from the present scope of the disclosure. The analysis of distance information can facilitate decentralized control processes that are expected to become more common as wireless radio control systems evolve, such as facilitating the analysis of distance information at individual eNodeBs in an LTE technology that can facilitate various aspects of a SON including self-healing and self-optimization by cooperation between eNodeBs with decreased or no centralized control.

In an aspect, neighbor relations between base stations can relate to neighbor relations between sector carriers of the base stations. Sector carriers can include one or more radios embodying one or more radio access technologies. Further, sector carriers can include one or more radios operating at one or more frequencies. A radio can include one or more antenna. As such, sector carriers of a base station can be separately associated with neighbor relations information associated with a relationship between said sector carriers. As an example, base station “A” can serve several sectors, such as sectors 1 to 3. A second base station, “B”, can serve several sectors, such as sectors 4 to 9. Neighbor relations can be between the radios of the base stations serving specific sectors, for example, between the radios serving sector A-2 (base station A, sector 2) and sector B-9 (base station B, sector 9), etc. In some embodiments, neighbor relations information for a base station can include, for example, neighbor relations information for one or more sector carrier pairs.

Where for one base station it is not permissible to have neighbor relationships towards two other base stations employing the same PCI, modification of the neighbor relations can be based on distance information. As an example, when a UE detects a new neighbor base station with the same PCI of an existing neighbor base station, the UE can have already entered the overlapping coverage of the new neighbor base station. If handover does not occur, the new neighbor base station can become an interferer in the downlink direction and the UE can become an uplink interferer towards the new neighbor. This example scenario can lead to two or more dropped calls. However, when the new neighbor is detected, if the UE reports the new neighbor GCI back towards the serving base station, then the serving base station can receive location information for the new neighbor based on the GCI. Furthermore, the serving base station can receive location information for existing neighbor base stations, more particularly neighbor base stations using the same PCI as the new neighbor base station. This location information can be employed to determine the distance between the new neighbor base station and the serving base station. Similarly, the location information can be employed to determine the distance between the existing neighbor base stations and the serving base station. These distance information can be employed in adapting the neighbor relations, for example, preferentially selecting the nearest neighbor base station, selecting the neighbor base station most closely matching a target distance, etc. Distance-based modification of neighbor relations, e.g., the selection order of base stations as neighboring base stations, can include neighbor prioritization, neighbor deletion, neighbor addition, alarm conditions, etc.

The following presents simplified example embodiments of the disclosed subject matter in order to provide a basic understanding of some aspects of the various embodiments. This is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an embodiment, a system can include a processor and memory. The processor can facilitate the execution of computer-executable instructions stored on the memory. The execution of the computer-executable instructions can cause the processor to receive radio information related to identification of a radio in a wireless communications system. Further, the processor can receive supplementary radio information, based on an identifier of the radio of the wireless communications system in response to the radio information being related to an identification conflict condition with another radio of the wireless communications network. The system can further determine an update for a neighbor base station relation information, based on distance information related to the supplementary radio information, to facilitate adaptation of a coverage area of the wireless communication system based on a set of neighbor base station relations and facilitate access to the update for the neighbor base station relation information.

In another embodiment, a method can include receiving, by a system including a processor, radio identification information for a first base station of a wireless communications network, wherein the first base station is a neighbor base station to a serving base station. The method can further include receiving first radio identification information for the first base station in response to the radio identification information matching second radio identification information for a second base station, wherein the second base station is another neighbor base station to the serving base station. Additionally, the method can include receiving second unique radio identification information for the second base station in response to the radio identification information matching the second radio identification information for the second base station of the wireless communications network. Receiving, by the system, first supplementary information related to the first radio identification information and second supplementary information related to the second radio identification information in response to receiving the first radio identification information and second radio identification information can be employed in determining an update for a neighbor base station relation information. This update can be based on first distance information related to the first supplementary radio information and second distance information second supplementary radio information, and can facilitate adaptation of a coverage area of the wireless communication system based on a set of neighbor base station relations. The method can additionally facilitate access to the update for the neighbor base station relation information.

In a further embodiment, a device of a base station such as an enhanced NodeB (eNodeB) can include a memory storing computer-executable instructions and a processor that facilitates execution of the computer-executable instructions. These instructions can cause the processor to receive first physical cell identifier (PCI) information for a first base station of a wireless communications network. The first base station can be a neighbor base station to a serving base station. The processor can further receive first global cell identity (GCI) information for the first base station, in response to first PCI information matching second PCI information for a second base station of the wireless communications network, wherein the second base station is also a neighbor base station to the serving base station. The first global cell identity information can uniquely identify the first base station in the wireless communications network. Additionally, the processor can receive second GCI information for the second base station, in response to first PCI information matching second PCI information. The second global cell identity information can uniquely identify the second base station in the wireless communications network. The processor can also receive first supplementary information related to the first radio identification information and second supplementary information related to the second radio identification information in response to receiving the first unique radio identification information and second radio identification information. As such, the processor can determine first distance information related to a distance between the first base station and the serving base station based, in part, on the first supplementary information. Similarly, the processor can also determine second distance information related to a distance between the second base station and the serving base station based, in part, on the second supplementary information. The processor can then determine an update for a neighbor base station relation information, based on first distance information and second distance information, to facilitate adaptation of a coverage area of the wireless communication system based on a set of neighbor base station relations and facilitate access to the update for the neighbor base station relation information.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

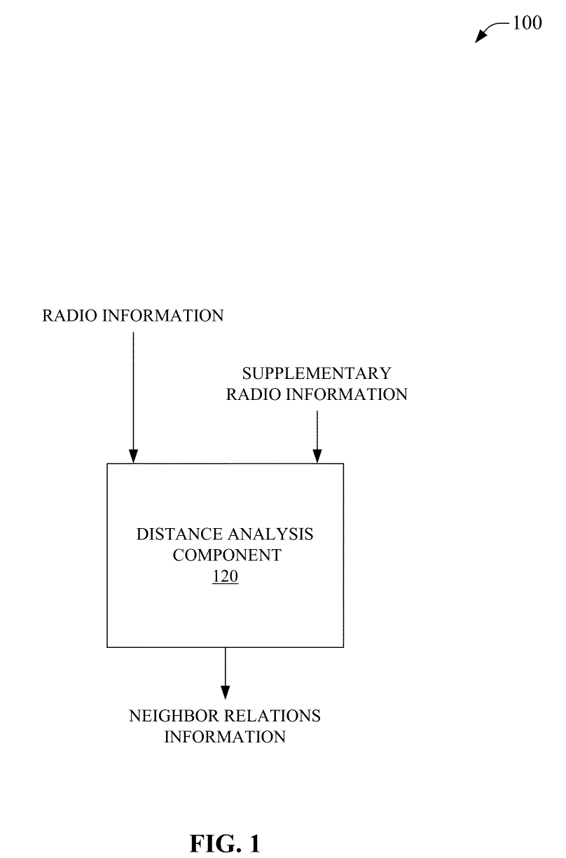

FIG. 1 is an illustration of a system 100, which facilitates distance-based modification of neighbor relations in accordance with aspects of the subject disclosure. System 100 can include distance analysis component 120. Distanced analysis component 120 can receive radio information related to a base station. Radio information can include identifier information for a base station. As an example, radio information can include physical cell identifier (PCI) information for one or more base stations of a radio area network. As a further example, radio information can include global cell identity (GCI) information for one or more base stations. Radio information can include other information related to a base station without departing from the scope of the subject disclosure, such as location information, timing information, performance information, etc. In an embodiment, radio information can include a PCI conflict indicator that can indicate the existence of a PCI conflict.

Distanced analysis component 120 can also receive supplementary radio information. Supplementary radio information can include location information related to identified base stations. As an example, supplementary radio information can include the location of an eNodeB based on the GCI of the eNodeB. As such, where a PCI conflict is determined for a first and second base station, corresponding GCI information can be employed to access location information for the first and second base stations. This can facilitate determining distance information related to the first and second base stations, such as determining which of the first and second base stations is located closed to a serving base station, determining which of the first and second base stations is located closer to a predetermined distance from a serving base station, etc.

Distance analysis component 120 can perform distance related analyses based on the received radio information and supplementary radio information. Distance related analyses can include determining relative locations of identified base stations. In an aspect, base stations can be associated with a neighbor relations data structure. The neighbor relations data structure can include ordered lists, tables, etc. The neighbor relations data structure can include preference information for selecting neighboring base stations in an automated neighbor selection technology, such as ANR for SON. As such, base station indicators can be ordered, added, deleted, marked for addition or deletion, marked as temporary, marked as banned, etc. in the neighbor relations data structure to facilitate neighbor relations in a wireless communications network.

Distance analysis component 120 can facilitate access to neighbor relations information. Neighbor relations information can be employed to update neighbor relations, for example, by modification of information in a neighbor relations data structure. These modifications can be based on the distance analysis performed by distance analysis component 120. As such, neighbor relations can be modified based on distance characteristics of base stations in a wireless communications network. Modification of neighbor relations can include prioritization of neighbor base stations, deletion of neighbor base stations, addition of neighbor base stations, etc.

In an embodiment, the distance analysis performed by distance analysis component 120 can identify the nearest neighbor base station from a set of base stations associated with a PCI conflict condition. Nearest neighbor analysis can be relative to a serving base station. As an example, where a UE is served by a serving base station, the UE can communicate PCI information to the serving base station to identify other detected base stations in range of the UE. As such, the UE can detect a plurality of other base stations that can include a PCI conflict condition, e.g., when two or more of the other base stations are employing the same PCI. Where a PCI conflict condition is detected, the UE can also receive GCI information for the base stations associated with the PCI conflict. As an example, a UE can query the plurality of base stations having conflicting PCIs for GCI information. The GCI information can be received by the serving base station by way of the UE. The GCI information can be employed to access location information. As an example, the GCI information can be employed in query of a wireless communications network database having location information for base stations comprising a RAN. This location information can then be employed to determine the distance between the serving base station and the other base stations involved in the PCI conflict. These distances can then be subjected to rules to determine neighbor relations information. In an embodiment, the rules can relate to prioritizing selection of a nearest neighbor in neighbor relations. In another embodiment, the rules can relate to prioritizing selection of a neighbor with a distance most closely matching a target distance. Of note, numerous other distance-based rules can be employed, such as deprioritizing selection of a neighbor base station that is closer than a minimum distance from the serving base station, etc., all such other distance-based rules are within the scope of the subject discloser despite lack of enumeration for brevity and clarity.

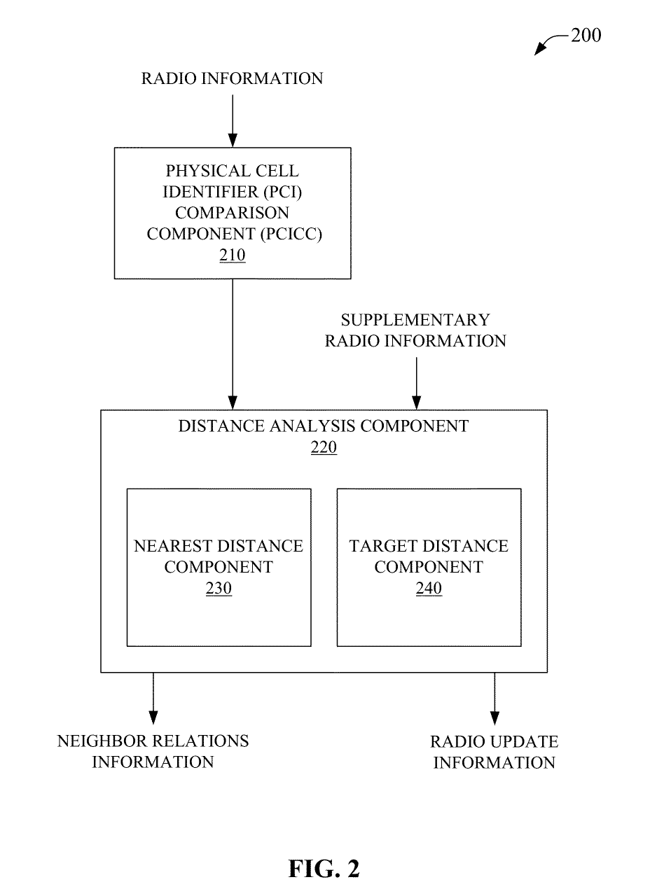

FIG. 2 is a depiction of a system 200 that can facilitate distance-based modification of neighbor relations and conflict resolution in accordance with aspects of the subject disclosure. System 200 can include physical cell identifier comparison component (PCICC) 210. PCICC 210 can receive radio information related to a base station. Radio information can include identifier information for a base station. As an example, radio information can include PCI information for one or more base stations of a radio area network. As a further example, radio information can include GCI information for one or more base stations. Radio information can include other information related to a base station without departing from the scope of the subject disclosure, such as location information, timing information, performance information, etc. In an embodiment, radio information can include a PCI conflict indicator that can indicate the existence of a PCI conflict.

In an aspect, PCICC 210 can receive PCI information for a plurality of base stations. These base stations, for example, can be detected by a UE and the PCI of the detected base stations can be communicated to PCICC 210. Moreover, in an embodiment, PCICC 210 can be located in a base station, e.g., an eNodeB. In a further embodiment, PCICC 210 can be located in another wireless communications network component or RAN component. In another embodiment, PCICC 210 can be located in a UE that can communicatively couple with other components of a wireless communications system, e.g., a base station, NodeB, eNodeB, etc. PCICC 210 can determine a PCI conflict by comparing PCIs for a set of detected base stations, such as those base stations included in the received radio information. Where more than one detected base station, either a newly detected base station or a previously detected base station, employ the same PCI, a PCI conflict can be present. A determined PCI conflict can be communicated to distance analysis component 220.

Furthermore, where a PCI conflict is determined, PCICC 210 can then receive GCI information for base stations associated with the conflict. In an aspect, GCI information can be received in response to a request or query of GCI information by way of PCICC 210 to the base stations associated with the PCI conflict. As an example, where a PCI conflict is determined, PCICC 210 can query the corresponding base stations for their GCI information. The queried base stations can then facilitate access to the GCI information in response to the query such that distanced analysis component 220 can receive the GCI information, e.g., by way of PCICC 210.

System 200 can include distanced analysis component 220 that can receive PCI conflict indications and corresponding radio information, including GCI information for base stations associated with an indicated PCI conflict. In an aspect, radio information can be received by way of PCICC 210. Furthermore, distanced analysis component 220 can receive supplementary radio information. Supplementary radio information can include location information related to base stations associated with the determined PCI conflict. As an example, supplementary radio information can include the location of an eNodeB based on the GCI of the eNodeB provided in response to the eNodeB being associated with a determined PCI conflict. As such, where a PCI conflict is determined for a first and second base station, corresponding GCI information can be employed to access location information for the first and second base stations. This can facilitate determining distance information related to the first and second base stations, such as determining which of the first and second base stations is located closed to a serving base station, determining which of the first and second base stations is located closer to a predetermined distance from a serving base station, etc.

Distance analysis component 220 can perform distance related analyses based on the received radio information and supplementary radio information in response to an indicated PCI conflict. Distance related analyses can include determining relative locations of identified base stations. In an aspect, base stations can be associated with a neighbor relations data structure. The neighbor relations data structure can include ordered lists, tables, etc. The neighbor relations data structure can include preference information for selecting neighboring base stations in an automated neighbor selection technology.

Distance analysis component 220 can facilitate access to neighbor relations information. Neighbor relations information can be employed to update neighbor relations, for example, by modification of information in a neighbor relations data structure. These modifications can be based on the distance analysis performed by distance analysis component 220. As such, neighbor relations can be modified based on distance characteristics of base stations in a wireless communications network. As an example, the preferential order for neighbor base station selection can be modified based on a distance analysis performed in response to a determination of a PCI conflict.

In an embodiment, the distance analysis performed by distance analysis component 220 can identify the neighbor base stations from a set of base stations associated with a PCI conflict condition. Neighbor analysis can be relative to a serving base station. As an example, where a UE is served by a serving base station, the UE can communicate PCI information to the serving base station to identify other detected base stations in range of the UE. As such, the UE can detect a plurality of other base stations that can include a PCI conflict condition. Where a PCI conflict condition is detected, the UE can also receive GCI information for the base stations associated with the PCI conflict. As an example, a UE can query the plurality of base stations having conflicting PCIs for GCI information. The GCI information can be received by the serving base station by way of the UE. The GCI information can be employed to access location information. This location information can then be employed by distance analysis component 220 to determine the distance between the serving base station and the other base stations involved in the PCI conflict. These distances can then be subjected to rules at distance analysis component 220 to determine neighbor relations information. In an embodiment, the rules can relate to prioritizing selection of a nearest neighbor in neighbor relations.

Distance analysis component 220 can include nearest distance component 230. Nearest distance component 230 can employ rules can relate to prioritizing selection of a nearest neighbor in neighbor relations. Of note, numerous other distance-based rules can be employed, such as deprioritizing selection of a neighbor base station that is farther than a predetermined distance from the serving base station, etc., all such other distance-based rules are within the scope of the subject discloser despite lack of enumeration for brevity and clarity

Distance analysis component 220 can also include target distance component 240. Target distance component 240 can employ rules can relate to prioritizing selection of a neighbor with a distance most closely matching a target distance. Of note, numerous other distance-based rules can be employed, such as deprioritizing selection of a neighbor base station that is closer than a predetermined distance from the serving base station, etc., all such other distance-based rules are within the scope of the subject discloser despite lack of enumeration for brevity and clarity.

In an aspect, distance analysis component 220 can facilitate access to radio update information. Radio update information can include information that facilitates updating a PCI of a base station associated with the determined PCI conflict. This can supplement prioritization of base stations neighbor relations such that a base station can be preferentially selected as a neighbor based on distance analysis and the underlying PCI conflict can be resolved. As an example, updating the PCI information of one or more of the base stations associated with the PCI conflict can resolve the conflicting PCI condition. As a second example, communicating the radio update information to a system that alters the radio area coverage of base station involved in the PCI conflict can also resolve the conflict. Altering the radio coverage can include adjusting the elevation, azimuth, and/or transmit power of a radio, in response to receiving radio update information, which can alter the physical coverage of the radio and resolve PCI conflicts by reducing the potential for overlap between base stations employing the same PCI.

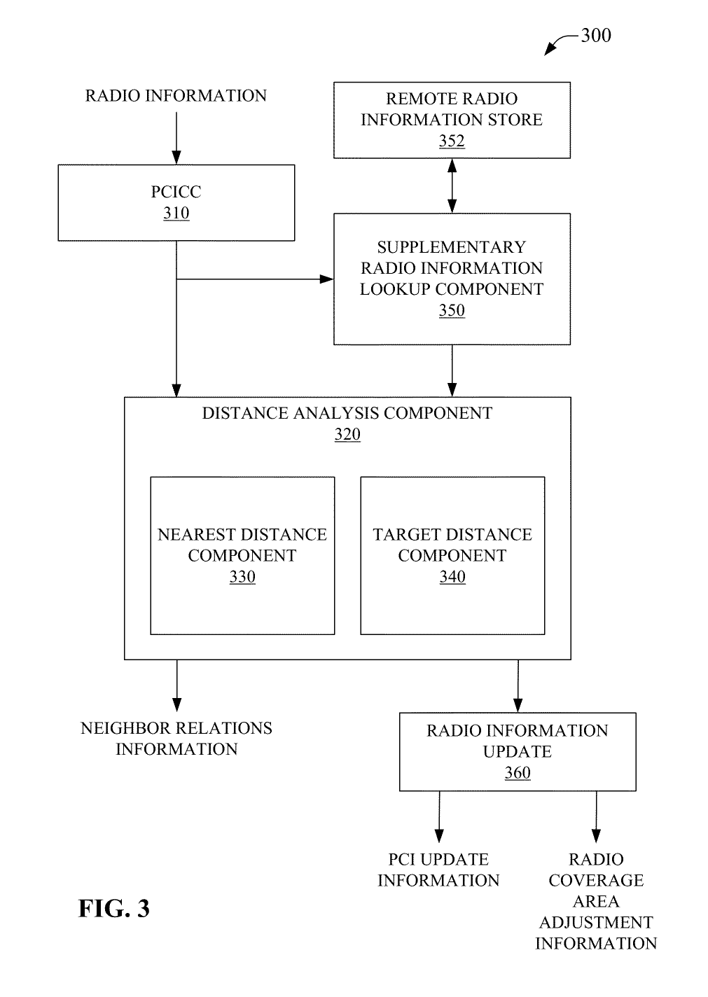

FIG. 3 illustrates a system 300 that facilitates distance-based modification of neighbor relations, conflict resolution, and coverage area adjustment in accordance with aspects of the subject disclosure. System 300 can include physical cell identifier comparison component (PCICC) 310. PCICC 310 can receive radio information related to a base station. Radio information can include identifier information for a base station. As an example, radio information can include PCI information for one or more base stations of a radio area network. As a further example, radio information can include GCI information for one or more base stations. Radio information can include other information related to a base station without departing from the scope of the subject disclosure, such as location information, timing information, performance information, etc. In an embodiment, radio information can include a PCI conflict indicator that can indicate the existence of a PCI conflict. In an aspect, PCICC 310 can receive PCI information for a plurality of base stations. PCICC 310 can determine a PCI conflict by comparing PCIs for a set of detected base stations, such as those base stations included in the received radio information. Where more than one detected base station employs the same PCI, a PCI conflict can be present. A determined PCI conflict can be communicated to distance analysis component 320.

Furthermore, where a PCI conflict is determined, PCICC 310 can communicate the conflict to supplementary radio information lookup component 350. Supplementary radio information lookup component 350 can then receive GCI information for base stations associated with the conflict. In an aspect, GCI information can be received in response to a request or query of GCI information by way of PCICC 310 to the base stations associated with the PCI conflict. As an example, where a PCI conflict is determined, PCICC 310 can query the corresponding base stations for their GCI information. The queried base stations can then facilitate access to the GCI information in response to the query such that supplementary radio information lookup component 350 can receive the GCI information, e.g., by way of PCICC 310. Supplementary radio information lookup component 350 can receive supplementary radio information by way of remote radio information store 352. Supplementary radio information can include location information related to base stations associated with the determined PCI conflict. As an example, supplementary radio information can include the location of an eNodeB based on the GCI of the eNodeB provided in response to the eNodeB being associated with a determined PCI conflict. As such, where a PCI conflict is determined for a first and second base station, corresponding GCI information can be employed to access location information for the first and second base stations. In an embodiment, remote radio information store 352 can be part of a wireless communications network core system, such as being located in a control center for a wireless communications network.

System 300 can further include distance analysis component 220 that can receive PCI conflict indications and corresponding radio information, including GCI information for base stations associated with an indicated PCI conflict. In an aspect, radio information can be received by way of PCICC 310. Furthermore, distance analysis component 320 can receive supplementary radio information by way of supplementary radio information lookup component 350. This can facilitate determining distance information related to base stations, such as determining which of a first and second base station is located closest to a serving base station, determining which of a first and second base station is located closer to a predetermined distance from a serving base station, etc.

Distance analysis component 320 can perform distance related analyses based on the received radio information and supplementary radio information in response to an indicated PCI conflict. Distance related analyses can include determining relative locations of identified base stations. In an aspect, base stations can be associated with a neighbor relations data structure. The neighbor relations data structure can include ordered lists, tables, etc. The neighbor relations data structure can include preference information for selecting neighboring base stations in an automated neighbor selection technology.

Distance analysis component 320 can facilitate access to neighbor relations information. Neighbor relations information can be employed to update neighbor relations, for example, by modification of information in a neighbor relations data structure. These modifications can be based on the distance analysis performed by distance analysis component 320. As such, neighbor relations can be modified based on distance characteristics of base stations in a wireless communications network. As an example, the preferential order for neighbor base station selection can be modified based on a distance analysis performed in response to a determination of a PCI conflict.

In an embodiment, the distance analysis performed by distance analysis component 320 can identify neighbor base stations from a set of base stations associated with a PCI conflict condition. Neighbor analysis can be relative to a serving base station. Where a PCI conflict condition is detected, the UE can also receive GCI information for the base stations associated with the PCI conflict. The GCI information can be employed to access location information, e.g., by way of supplementary radio information. This location information can then be employed by distance analysis component 320 to determine the distance between the serving base station and the other base stations involved in the PCI conflict. These distances can then be subjected to rules at distance analysis component 320 to determine neighbor relations information. In an embodiment, the rules can relate to prioritizing selection of a nearest neighbor in neighbor relations. As an example, neighbor relations can be modified if a new neighbor base station is closer than an existing same-PCI neighbor base station by adding the new neighbor to the neighbor list and proceeding with handover to the new neighbor. However, in this example, if the new neighbor is further than the existing same-PCI neighbor, rather than adding the new base station to the neighbor list, it can trigger an inter-frequency LTE handover or, if another LTE frequency carrier is not available, an inter-radio access technology handover to some other radio technology to avoid dropping the call. Further, a PCI collision alarm can be reported such that the conflicting PCIs can be resolved, such as by changing the PCI of one of the base stations in conflict, adjusting coverage areas, etc.

Distance analysis component 320 can include nearest distance component 330. Nearest distance component 330 can employ rules can relate to prioritizing selection of a nearest neighbor in neighbor relations. Distance analysis component 320 can also include target distance component 340. Target distance component 340 can employ rules can relate to prioritizing selection of a neighbor with a distance most closely matching a target distance. Of note, numerous other distance-based rules can be employed, such as deprioritizing selection of a neighbor base station that is closer than a predetermined distance from the serving base station, etc., all such other distance-based rules are within the scope of the subject discloser despite lack of enumeration for brevity and clarity.

In an aspect, distance analysis component 320 can be communicatively coupled to radio information update component 360 that can facilitate access to radio update information and other PCI conflict resolution information. Radio information update component 360 can include information that facilitates updating a PCI of a base station associated with the determined PCI conflict. This can supplement prioritization of base stations neighbor relations such that a base station can be preferentially selected as a neighbor based on distance analysis and the underlying PCI conflict can be resolved. As an example, updating the PCI information of one or more of the base stations associated with the PCI conflict can resolve the conflicting PCI condition. Radio information update component 360 can also include facilitating access to radio coverage area adjustment information. Radio coverage area adjustment information can facilitate altering the radio area coverage of base stations involved in the PCI conflict. As an example, altering the radio coverage area can include adjusting the elevation, azimuth, and/or transmit power of a radio, in response to receiving radio update information, which can alter the physical coverage of the radio and resolve PCI conflicts by reducing the potential for overlap between base stations employing the same PCI.

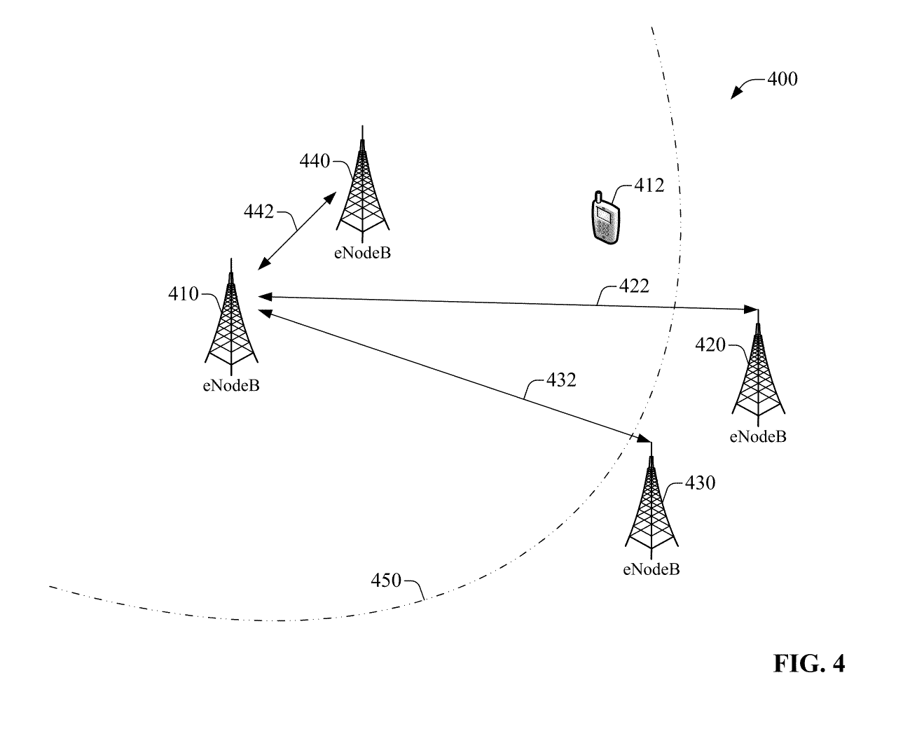

FIG. 4 is a graphic 400 of RAN conditions related to distance-based modification of neighbor relations in accordance with aspects of the subject disclosure. Graphic 400 can illustrates a serving base station 410. UE 412 can be served by base station 410. UE 412 can also detect base stations 420, 430 and 440. Base station 420 can be an existing neighbor. Base stations 430 and 440 can be newly detected base stations. Base station 430 can employ the same PCI as base station 420 and, as such, can be part of a PCI conflict. UE 412 can detect the same PCI from both base station 420 and 430 and communicate this to serving base station 410. This can result in determining the distance 422 between serving base station 410 and base station 420. This can also result in determining the distance 432 between serving base station 410 and base station 430. Based on the determined distances 422 and 432, neighbor relations can be modified. As an example, where distance 432 is less than distance 422, base station 430 can be added to the neighbor relations data structure and prioritized over base station 420. Further, base station 420 can be marked for deletion or deprioritized due to the addition of base station 430. Additionally, the PCI value of either base station 420 or 430 can be updated to remove the conflict condition. Further, the coverage area of base station 420 or 430 can be adjusted, e.g., modifying tilt, angle and/or transmit power, to remove the overlap condition and resolve the PCI conflict with or without updating the PCI value.

UE 412 can also detect the same PCI from both base station 420 and 440 and communicate this to serving base station 410. This can result in determining the distance 422 between serving base station 410 and base station 420. This can also result in determining the distance 442 between serving base station 410 and base station 440. Based on the determined distances 422 and 442, neighbor relations can be modified. As an example, where target distance 450, with respect to serving base station 410, has been determined, modification of neighbor relations can include blocking base station 440 from addition to the neighbor relations data structure because it is closer than the target distance 450. As a further example, modification of neighbor relations can include blocking base station 440 from addition to the neighbor relations data structure because base station 420 remains closer to target distance 450 than newly detected base station 440. As a still further example, modification of neighbor relations can include adding base station 440 and prioritizing it over base station 420 on the neighbor relations data structure because base station 420 is beyond target distance 450 and base station 440 is within target distance 450. It will be noted that nearly a limitless number of other examples can be presented for distance-based modification of neighbor relations, all of which are considered within the scope of the present disclosure, however these other examples are not expressly recited simply for the sake of clarity and brevity.

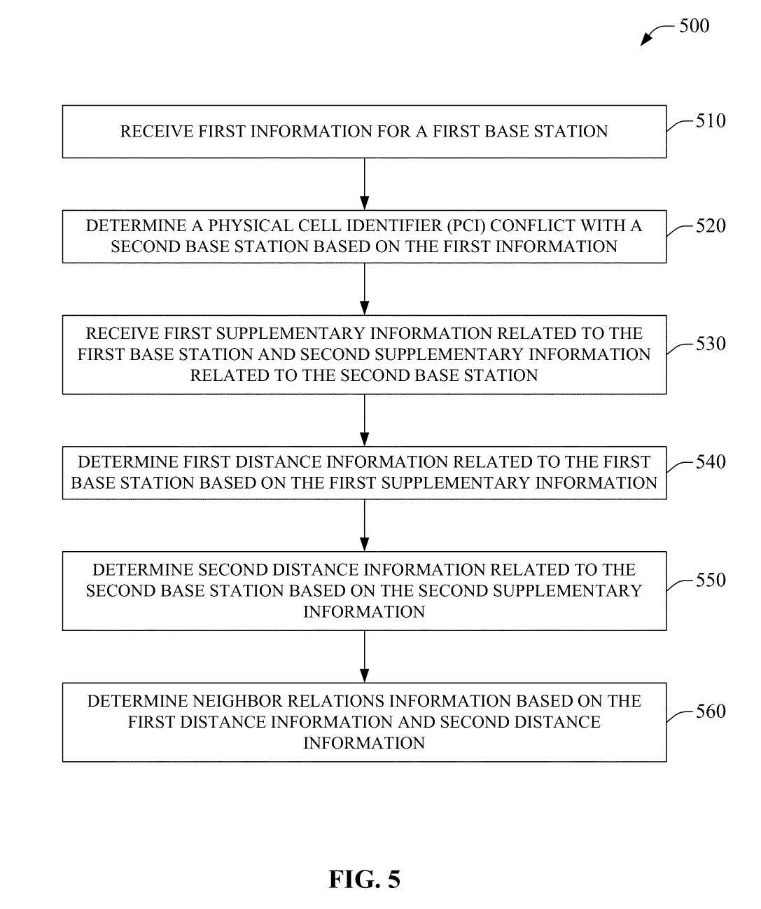

In view of the example system(s) described above, example method(s) that can be implemented in accordance with the disclosed subject matter can be better appreciated with reference to flowcharts in FIG. 5-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 5 illustrates aspects of method 500 facilitating distance-based modification of neighbor relations in accordance with aspects of the subject disclosure. At 510, first information for a first base station can be received. First information can include identifier information for a base station. As an example, first information can include physical cell identifier (PCI) information for one or more base stations of a radio area network. As a further example, first information can include global cell identity (GCI) information for one or more base stations. First information can include other information related to a base station without departing from the scope of the subject disclosure, such as location information, timing information, performance information, etc. In an embodiment, first information can include a PCI conflict indicator that can indicate the existence of a PCI conflict.

At 520, a PCI conflict with a second base station can be determined based on the first information. In an aspect, PCI information for the second base station can be compared to PCI information included in the first information for the first base station to determine the presence of a PCI conflict in which the PCI of the first and second base station are the same.

At 530, first supplementary information related to the first base station can be received and second supplementary information related to the second base station can be received. Receiving the first and second supplementary information can be in response to the presence of a PCI conflict at 520. First and second supplementary information can each include location information related to respective base stations. As an example, first supplementary information can include the location of an eNodeB based on the GCI of the eNodeB. As such, where a PCI conflict is determined for a first and second base station, corresponding GCI information can be employed to access location information for the first and second base stations. This can facilitate determining distance information related to the first and second base stations, such as determining which of the first and second base stations is located closed to a serving base station, determining which of the first and second base stations is located closer to a predetermined distance from a serving base station, etc.

At 540, first distance information related to the first base station can be determined. First distance information can be based on the first supplementary information. At 550, second distance information related to the second base station can be determined. Second distance information can be based on the second supplementary information. In an embodiment, the distance information can be employed to select a neighbor base station from a set of base stations associated with a PCI conflict condition. Neighbor analysis can include determining a distance between a conflicting base station, e.g., the first or second base stations, and a serving base station. As an example, where a UE is served by a serving base station, the UE can communicate PCI information to the serving base station to identify other detected base stations in range of the UE, e.g., the first or second base stations. Where a PCI conflict condition is detected, the UE can also receive GCI information for the base stations associated with the PCI conflict. As an example, a UE can query the first and second base stations for GCI information. The GCI information can be received by the serving base station by way of the UE. The GCI information can be employed to access location information as part of the supplementary information at 530. As an example, the GCI information can be employed in query of a wireless communications network database having location information for the first and second base stations. This location information can then be employed to determine the distance between the serving base station and the first base station, and the serving base station and the second base station. These distances can then be subjected to rules to determine neighbor relations information.

At 560, neighbor relations information can be determined based on the first distance information and the second distance information. Determining neighbor relations information can be based on one or more rules pertaining to distance-based modification of neighbor relations. In an embodiment, the rules can relate to prioritizing selection of a nearest neighbor in neighbor relations. In another embodiment, the rules can relate to prioritizing selection of a neighbor based on the determined distance compared to a target distance. Of note, numerous other distance-based rules can be employed, such as deprioritizing selection of a neighbor base station that is closer than a predetermined distance from the serving base station, deprioritizing selection of a neighbor base station that is farther than a predetermined distance from the serving base station, etc., all such other distance-based rules being within the scope of the subject disclosure.

Distance related analyses can include determining relative locations of identified base stations. In an aspect, base stations can be associated with a neighbor relations data structure. The neighbor relations data structure can include ordered lists, tables, etc. The neighbor relations data structure can include preference information for selecting neighboring base stations in an automated neighbor selection technology, such as automatic neighbor relations (ANR) for self-organizing networks (SON). As such, base station indicators can be ordered, added, deleted, marked for addition or deletion, marked as temporary, marked as banned, etc. in the neighbor relations data structure to facilitate neighbor relations in a wireless communications network.

Neighbor relations information can be employed to update neighbor relations, for example, by modification of information in a neighbor relations data structure. These modifications can be based on the distance analysis performed at 550. As such, neighbor relations can be modified based on neighbor relations information, at 560, relating to the distance characteristics of base stations in a wireless communications network. Modification of neighbor relations can include prioritization of neighbor base stations, deletion of neighbor base stations, addition of neighbor base stations, etc. At this point, method 500 can end.

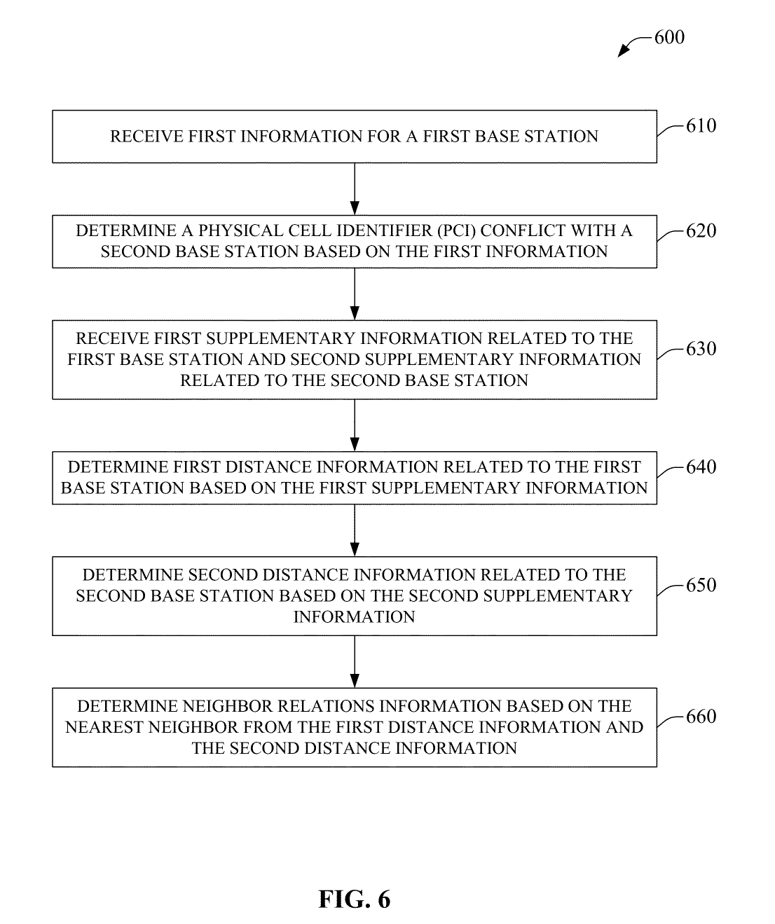

FIG. 6 illustrates aspects of method 600 facilitating nearest neighbor distance-based modification of neighbor relations in accordance with aspects of the subject disclosure. At 610, first information for a first base station can be received. First information can include identifier information for a base station, including PCI information for one or more base stations of a radio area network, GCI information for one or more base stations, etc.

At 620, a PCI conflict with a second base station can be determined based on the first information. In an aspect, PCI information for the second base station can be compared to PCI information included in the first information for the first base station to determine the presence of a PCI conflict in which the PCI of the first and second base station are the same.

At 630, first supplementary information related to the first base station can be received and second supplementary information related to the second base station can be received. Receiving the first and second supplementary information can be in response to the presence of a PCI conflict at 620. First and second supplementary information can each include location information related to respective base stations. In an aspect, where a PCI conflict is determined for a first and second base station, corresponding GCI information can be employed to access location information for the first and second base stations. This can facilitate determining distance information related to the first and second base stations.

At 640, first distance information related to the first base station can be determined. First distance information can be based on the first supplementary information. At 650, second distance information related to the second base station can be determined. Second distance information can be based on the second supplementary information. In an embodiment, the distance information can be employed to select a neighbor base station from a set of base stations associated with a PCI conflict condition. Neighbor analysis can include determining a distance between a conflicting base station and a serving base station. Where a PCI conflict condition is detected, the UE can also receive GCI information for the base stations associated with the PCI conflict. The GCI information can be employed to access location information as part of the supplementary information at 630. This location information can then be employed to determine the distance between the serving base station and the PCI conflicting base stations respectively. These distances can then be subjected to rules to determine neighbor relations information.

At 660, neighbor relations information relating to the nearest neighbor can be determined based on the first distance information and the second distance information. As an example, neighbor relations can be prioritized to preferentially select the first or second base station depending on which one is nearer to the serving base station. At this point, method 600 can end.

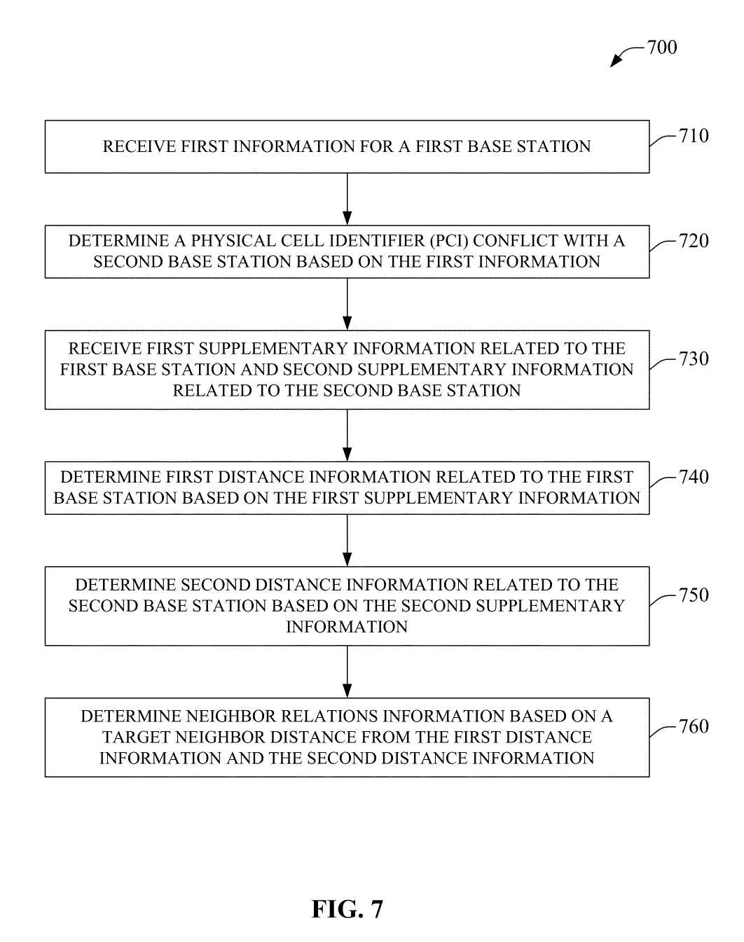

FIG. 7 illustrates a method 700 that facilitates target neighbor distance distance-based modification of neighbor relations in accordance with aspects of the subject disclosure. At 710, first information for a first base station can be received. First information can include identifier information for a base station, including PCI information for one or more base stations of a radio area network, GCI information for one or more base stations, etc.

At 720, a PCI conflict with a second base station can be determined based on the first information. In an aspect, PCI information for the second base station can be compared to PCI information included in the first information for the first base station to determine the presence of a PCI conflict in which the PCI of the first and second base station are the same.

At 730, first supplementary information related to the first base station can be received and second supplementary information related to the second base station can be received. Receiving the first and second supplementary information can be in response to the presence of a PCI conflict at 720. First and second supplementary information can each include location information related to respective base stations. In an aspect, where a PCI conflict is determined for a first and second base station, corresponding GCI information can be employed to access location information for the first and second base stations. This can facilitate determining distance information related to the first and second base stations.

At 740, first distance information related to the first base station can be determined. First distance information can be based on the first supplementary information. At 750, second distance information related to the second base station can be determined. Second distance information can be based on the second supplementary information. In an embodiment, the distance information can be employed to select a neighbor base station from a set of base stations associated with a PCI conflict condition. Neighbor analysis can include determining a distance between a conflicting base station and a serving base station. Where a PCI conflict condition is detected, the UE can also receive GCI information for the base stations associated with the PCI conflict. The GCI information can be employed to access location information as part of the supplementary information at 730. This location information can then be employed to determine the distance between the serving base station and the PCI conflicting base stations respectively. These distances can then be subjected to rules to determine neighbor relations information.

At 760, neighbor relations information can be determined based on a target neighbor distance relative to the first distance and the second distance. As an example, neighbor relations can be prioritized to preferentially select the first or second base station depending on which one has a distance to the serving base station closer to a target distance. As further example, neighbor relations can be prioritized to preferentially select the first or second base station depending on their distance to the serving base station being greater than a target distance. As another example, neighbor relations can be prioritized to preferentially select the first or second base station depending on their distance to the serving base station being less than a target distance. At this point, method 700 can end.

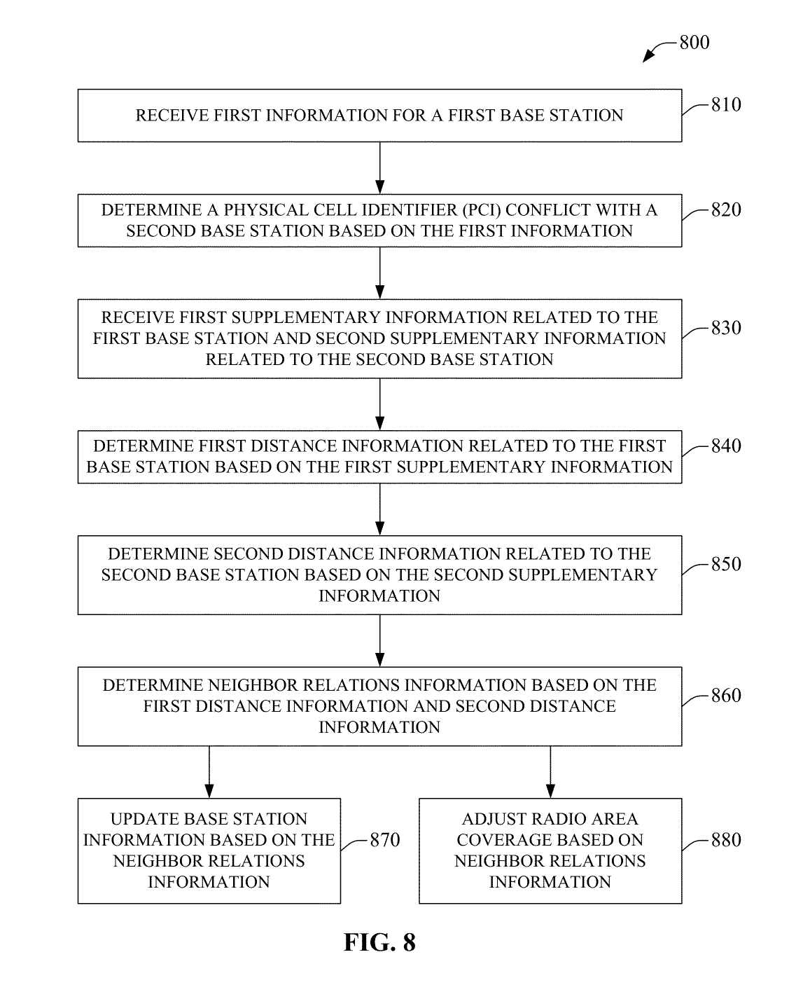

FIG. 8 illustrates a method 800 that facilitates distance-based modification of neighbor relations and conflict resolution in accordance with aspects of the subject disclosure. At 810, first information for a first base station can be received. First information can include identifier information for a base station, including PCI information for one or more base stations of a radio area network, GCI information for one or more base stations, etc.

At 820, a PCI conflict with a second base station can be determined based on the first information. In an aspect, PCI information for the second base station can be compared to PCI information included in the first information for the first base station to determine the presence of a PCI conflict in which the PCI of the first and second base station are the same.

At 830, first supplementary information related to the first base station can be received and second supplementary information related to the second base station can be received. Receiving the first and second supplementary information can be in response to the presence of a PCI conflict at 820. First and second supplementary information can each include location information related to respective base stations. In an aspect, where a PCI conflict is determined for a first and second base station, corresponding GCI information can be employed to access location information for the first and second base stations. This can facilitate determining distance information related to the first and second base stations.

At 840, first distance information related to the first base station can be determined. First distance information can be based on the first supplementary information. At 850, second distance information related to the second base station can be determined. Second distance information can be based on the second supplementary information. In an embodiment, the distance information can be employed to select a neighbor base station from a set of base stations associated with a PCI conflict condition. Neighbor analysis can include determining a distance between a conflicting base station and a serving base station. Where a PCI conflict condition is detected, the UE can also receive GCI information for the base stations associated with the PCI conflict. The GCI information can be employed to access location information as part of the supplementary information at 830. This location information can then be employed to determine the distance between the serving base station and the PCI conflicting base stations respectively. These distances can then be subjected to rules to determine neighbor relations information.

At 860, neighbor relations information can be determined based on the first distance information and the second distance information. Determining neighbor relations information can be based on one or more rules pertaining to distance-based modification of neighbor relations. In an embodiment, the rules can relate to prioritizing selection of a nearest neighbor in neighbor relations. In another embodiment, the rules can relate to prioritizing selection of a neighbor based on the determined distance compared to a target distance.

At 870, base station information can be update based on the neighbor relations information determined at 860. Updating base station information can include updating base station PCI values. As such, a PCI value can be updated to correct a PCI conflict condition by changing a PCI value to a non-matching PCI value for a base station associated with a PCI conflict at 820.

At 880, radio area coverage can be adjusted based on neighbor relations information from 860. Radio coverage area adjustment can facilitate altering the radio area coverage of base stations involved in a PCI conflict. As an example, altering the radio coverage area can include adjusting the elevation, azimuth, and/or transmit power of a base station radio, which can alter the physical coverage of the radio and resolve PCI conflicts by reducing the potential for overlap between base stations employing the same PCI. At this point, method 800 can end.

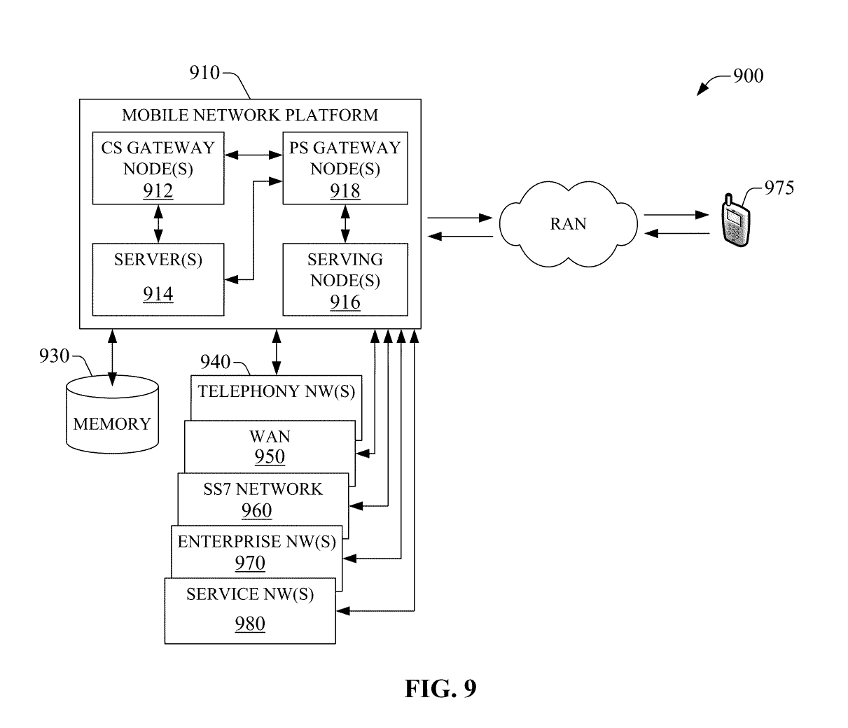

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload RAN resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In an aspect, memory 930 can be, for example, accessed as part of a data store component or as a remotely connected memory store.

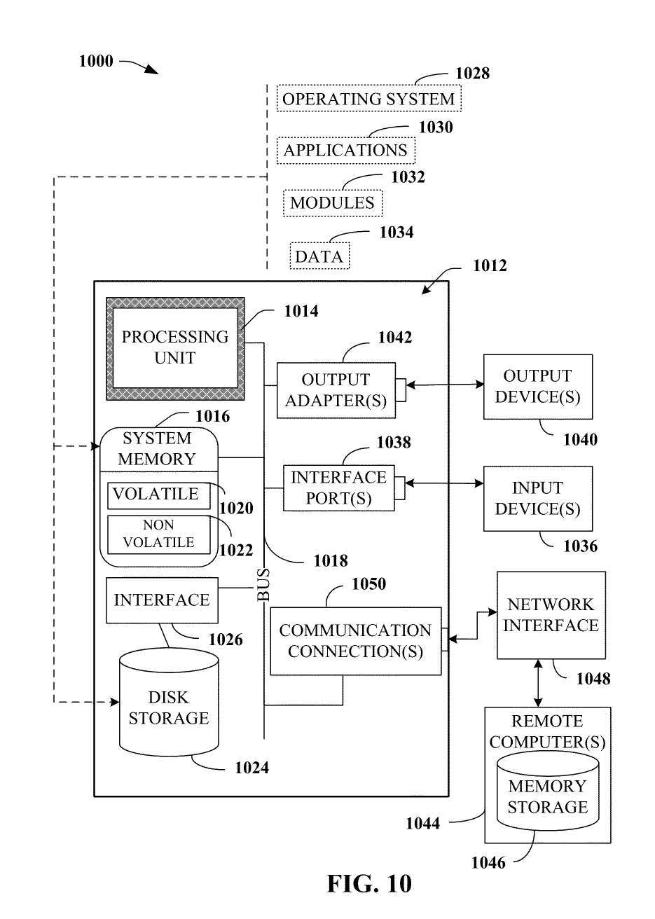

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of a mobile reporting component or UE (e.g., UE 412, distance analysis component 120, 220, 320, PCICC 210, 310, Supplementary radio information lookup component 350, etc.), a RAN component (e.g., base station 410, 420, 430, 440, etc.), a response component (e.g., remote radio information store 352), etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile reporting component 250 can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “Node B,” “evolved Node B (eNode B),” “home Node B (HNB),” “home access point (HAP),” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory that stores computer-executable instructions; and
a processor, communicatively coupled to the memory, that facilitates execution of the computer-executable instructions to at least:
receive radio information related to identification of a radio in a wireless communications system;
receive supplementary radio information based on an identifier of the radio of the wireless communications system in response to a determination that the radio information is related to an identification conflict condition with another radio of the wireless communications network;
determine an update for neighbor base station relation information, based on distance information related to the supplementary radio information, to facilitate adaptation of a coverage area of the wireless communication system based on relation information for a set of neighbor base station relations; and
facilitate access to the update for the neighbor base station relation information.

2. The system of claim 1, wherein the neighbor base station relation information is stored in a data structure representing the set of neighbor base station relations and the update for the neighbor base station relation information facilitates a modification of the data structure.

3. The system of claim 1, wherein the adaptation of the coverage area includes management of a data structure representing the set of neighbor base station relations including a deletion of an identity of a neighbor base station from the set of neighbor base station relations.

4. The system of claim 1, wherein the adaptation of the coverage area includes management of a data structure representing the set of neighbor base station relations including an addition of an identity of a neighbor base station to the set of neighbor base station relations.

5. The system of claim 1, wherein the adaptation of the coverage area includes management of a data structure representing the set of neighbor base station relations including a prioritization of an identity of a neighbor base station of the set of neighbor base station relations.

6. The system of claim 1, wherein the radio information includes physical cell identity information and the identification conflict condition is a physical cell identity conflict condition.

7. The system of claim 1, wherein the identifier of the radio of the wireless communications system includes global cell identity information.

8. The system of claim 1, wherein the update is determined based on a minimization of a distance between a serving base station of the wireless communications system and the radio of the wireless communications system.

9. The system of claim 1, wherein the update is determined based on a determination of a value based on a comparison of a predetermined distance to a distance between a serving base station of the wireless communications system and the radio of the wireless communications system.

10. The system of claim 9, wherein the determination of the value is based on the predetermined distance being greater than the distance.

11. The system of claim 9, wherein the determination of the value is based on the predetermined distance being less than the distance.

12. The system of claim 9, wherein the determination of the value based on the comparison includes a differential value being determined, wherein the differential value is ranked according to a ranking and represents a difference between the predetermined distance and the distance.

13. A method, comprising:
receiving, by a system including a processor, radio identification information for a first base station of a wireless communications network, wherein the first base station is a neighbor base station to a serving base station;
receiving, by the system, first radio identification information for the first base station of the wireless communications network, in response to the radio identification information matching second radio identification information for a second base station of the wireless communications network, wherein the second base station is another neighbor base station to the serving base station;
receiving, by the system, second radio identification information for the second base station of the wireless communications network, in response to the radio identification information matching the second radio identification information for the second base station of the wireless communications network;
receiving, by the system, first supplementary information related to the first radio identification information and second supplementary information related to the second radio identification information in response to the receiving the first radio identification information and the second radio identification information,
determining, by the system, an update for a neighbor base station relation information, based on first distance information related to the first supplementary radio information and second distance information related to the second supplementary radio information, to facilitate adaptation of a coverage area of the wireless communication system based on a set of neighbor base station relations; and
facilitating, by the system, access to the update for the neighbor base station relation information.

14. The method of claim 13, wherein the determining the update includes determining that the first base station or the second base station is closer to the serving base station based on the first distance information related to the first supplementary radio information and the second distance information related to the second supplementary radio information.

15. The method of claim 13, wherein the determining the update includes determining a first proximity to a predetermined distance from the serving base station for the first base station and a second proximity to the predetermined distance from the serving base station for the second base station based on the first distance information related to the first supplementary radio information and the second distance information related to the second supplementary radio information.

16. The method of claim 13, wherein the adaptation of the coverage area includes adding the first base station to a data structure representing the set of neighbor base station relations.

17. The method of claim 13, wherein the adaptation of the coverage area includes deleting the first base station from a data structure representing the set of neighbor base station relations.

18. The method of claim 13, wherein the adaptation of the coverage area includes prioritizing a neighbor base station represented in a data structure defining the set of neighbor base station relations.

19. A device of a base station of a wireless communications network, comprising:
a memory that stores computer-executable instructions; and
a processor, communicatively coupled to the memory, that facilitates execution of the computer-executable instructions to at least:
receive first physical cell identifier information for a first base station of a wireless communications network, wherein the first base station is a neighbor base station to a serving base station;
receive first global cell identity information for the first base station, in response to first physical cell identifier information matching second physical cell identifier information for a second base station of the wireless communications network, wherein the second base station is another neighbor base station to the serving base station and the first global cell identity information identifies the first base station in the wireless communications network;
receive second global cell identity information for the second base station, in response to first physical cell identifier information matching second physical cell identifier information, wherein the second global cell identity information identifies the second base station in the wireless communications network;
receive first supplementary information related to the first radio identification information and second supplementary information related to the second radio identification information in response to receiving the first radio identification information and the second radio identification information;
determine first distance information related to a first distance between the first base station and the serving base station based, in part, on the first supplementary information;
determine second distance information related to a second distance between the second base station and the serving base station based, in part, on the second supplementary information; and
determine an update for neighbor base station relation information, based on the first distance information and the second distance information, to facilitate adaptation of a coverage area of the wireless communication system based on a set of neighbor base station relations.

20. The device of claim 20, wherein the update for neighbor base station relation information includes determining a prioritization of the first base station with regard to the second base station, the neighbor base station relation information is stored in a data structure representing the set of neighbor base station relations, the update for the neighbor base station relation information facilitates a modification of the data structure to reflect the prioritization and the device facilitates access to the update for the neighbor base station relation information.
